(19) United States
(12) Patent Application Publication
(10) Pub. No.: US 2025/0230337 A1
(43) Pub. Date: Jul. 17, 2025

(54) POLYASPARTATE-BASED TWO-COMPONENT COATING COMPOSITIONS FOR PRODUCING COATINGS HAVING GOOD SELF-HEALING PROPERTIES COUPLED WITH LOW TACKINESS

(71) Applicant: Covestro Deutschland AG, Leverkusen (DE)

(72) Inventors: Jan Suetterlin, Köln (DE); Matthias Wintermantel, Hürth (DE); Thomas Schuettler, Köln (DE); Anna-Marie Zorn, Ettlingen (DE); Dirk Dijkstra, Leverkusen (DE); Karl Josef Stuehler, Köln (DE); Andreas Hebestreit, Wipperfürth (DE)

(21) Appl. No.: 18/854,103

(22) PCT Filed: Apr. 19, 2023
(86) PCT No.: PCT/EP2023/060120

§ 371 Date: Oct. 4, 2024

(30) Foreign Application Priority Data
Apr. 21, 2022 (EP) 22169156.1

(51) Int. Cl. C09D 175/12; C08G 18/10; C08G 18/34; C08G 18/50; C08G 18/66; C08G 18/73

(52) U.S. Cl. CPC C09D 175/12; C08G 18/10; C08G 18/346; C08G 18/5024; C08G 18/6692; C08G 18/73

(57) ABSTRACT

The present invention relates to two-component coating compositions containing polyaspartic ester and polyether polyol-based polyurethane prepolymers, wherein the proportion of polyols, polyether polyols and polyether polyamines and the proportion of components having a functionality >2 in the coating composition (excluding auxiliaries, additives and solvents) are in a defined range, to a process for producing these compositions, to the use thereof for producing coatings and to the use of these coatings as a protective coating, in particular for objects that are subjected to (repeated) mechanical stresses.

The present invention relates to two-component coating compositions comprising polyaspartic esters and polyether polyol-based polyurethane prepolymers in which the proportion of polyols, polyether polyols, and polyether polyamines and also the proportion of components having a functionality of >2 in the coating composition (excluding auxiliaries, additives, and solvents) are within a defined range, to a process for producing these compositions, to the use thereof for the production of coatings, and to the use of these coatings as protective coatings, especially for objects exposed to (repeated) mechanical stresses.

Two-component (2K) coating compositions comprising a polyisocyanate component as binder in combination with a reactive component that is reactive toward isocyanate groups, in particular a polyhydroxyl component, have long been known. They are suitable for producing high-quality coatings that can be tailored to make them hard, elastic, resistant to abrasion and solvents and, above all, stable to weathering.

Within this 2K polyurethane coating technology, certain secondary polyamines containing ester groups have become established in recent years that, in combination with paint polyisocyanates, are particularly suitable as binders in low-solvent or solvent-free (high-solids) coating compositions and allow rapid curing of the coatings at low temperatures. These secondary polyamines are so-called polyaspartic esters, as described for example in EP0403921. The use thereof in 2K coating compositions, either alone or in a mixture with further components that are reactive toward isocyanate groups, is described for example in EP0403921, EP0639628, EP0667362, EP0689881, U.S. Pat. No. 5,214,086, EP0699696, EP0596360, EP0893458, DE19701835, and U.S. Pat. No. 5,243,012.

Surfaces of objects exposed to repeated mechanical stresses benefit from the ability to self-heal. This allows fatigue damage to be reduced. If impact loads are involved, the impact energy needs to be absorbed without material failure. The material must not be brittle; rather, it needs to be elastic. Elastic materials have the characteristic feature of a high elongation at break. At the same time, a low glass transition temperature is helpful in order that the materials do not become brittle and remain elastic even at high impact speeds (time-temperature superposition principle). An example of an application in which materials that can withstand repeated impact loads at high impact speeds are advantageous is the edge protection of wind turbine blades (“leading edge protection”).

Materials with self-healing properties may have the disadvantage of tack. This is undesirable particularly in the case of coatings, since particles of all kinds (for example dust or sand) stay stuck to the coating. This can bring disadvantages in the respective applications, for example higher air resistances or undesirable haptics.

Coatings that exhibit good self-healing coupled with low tack are therefore particularly desirable.

The present invention reports for the first time on the self-healing properties of coating compositions comprising polyaspartic esters.

The object of the present invention was to provide coatings that have good self-healing abilities while at the same time having low tack. Adequate self-healing abilities are in the context of the present invention defined as an elongation at break of >40% after self-healing for 24 h (i.e. storage at 23° C., 50% relative humidity). It is known that tack increases as the modulus of a material decreases (C. A. Dahlquist, “Adhesion—Fundamentals and Practice—A Report of an International Conference held at the University of Nottingham, England 20-22 Sep. 1966”, Maclaren and Sonst Ltd, London). For the purposes of the invention, low tack is a storage modulus of >0.7 MPa at 23° C. and 1 Hz (determined by dynamic mechanical analysis). A further object of the invention was to provide coatings having an elongation at break in the undamaged state of >100% and a glass transition temperature (determined via maximum tangent delta at 1 Hz) of <23° C.

This object was achieved by the two-component coating compositions described below, comprising polyaspartic esters and polyether polyol-based polyurethane prepolymers in which the proportion of polyols, polyether polyols, and polyether polyamines and also the proportion of components having a functionality of >2 in the coating composition (excluding auxiliaries, additives, and solvents) are within a defined range.

WO 2004/033517 A1, WO 2020/016292 A1, and WO 2020/094689 A1 describe coating compositions based on polyaspartic esters and polyether polyol-based polyurethane prepolymers. In WO 2004/033517 A1 and WO 2020/016292 A1, polyether polyols based on propylene oxide and/or ethylene oxide are mainly used, whereas WO 2020/094689 also describes the use of other polyether polyols, for example trimethylene-oxide-based polyether polyols.

However, none of these documents discloses a coating composition in which both the proportion of polyols, polyether polyols, and polyether polyamines and the proportion of components having a functionality of >2 are within the ranges defined in claim 1, even less the effect to be obtained by this combination of features.

WO 2020/260578 A1 likewise discloses in the examples section an aspartate-based coating composition (coating 6) that contains a polyether-based allophanate prepolymer as curing agent. Despite the curing agent not being a urethane prepolymer, the proportion of components having a functionality of >2 in the coating composition is much too high. The coating does not have adequate self-healing properties, as can be seen from example 35 of the experimental section of the present document.

The present invention provides two-component coating compositions (2K coating compositions) comprising
A) at least one polyaspartic-ester-containing component that comprises
   one or more polyaspartic esters of the general formula (I)

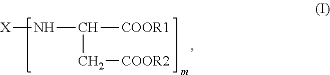

in which
m is an integer >1, preferably 2,
X is an m-valent organic radical, optionally containing one or more heteroatoms, as can be obtained by removing the primary amino groups from a polyamine or polyetheramine that has cycloaliphatically, linear-aliphatically or araliphatically attached primary amino groups and is in the 60 to 6000 g/mol molecular weight range and which may contain further functional groups reactive toward isocyanate groups and/or functional groups inert at temperatures of up to 100° C., and
the radicals R1 and R2 are identical or different organic radicals each having 1 to
18 carbon atoms,
and optionally one or more polyaspartic esters of the general formula (II)

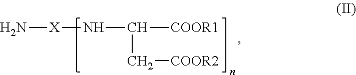

in which n is m-1, and X and the radicals R1 and R2 are as defined above,
or consists thereof and is obtainable by reacting
A1) at least one polyamine or polyether polyamine of the general formula (III),

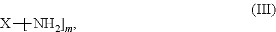

in which m and X are as defined above,
with
A2) at least one compound of the general formula (IV)

R1OOC≡CH═CH—COOR2 (IV),
in which R1 and R2 are as defined above,
B) at least one NCO-functional polyurethane prepolymer obtainable by reacting
B1) at least one polyisocyanate with
B2) at least one polyether polyol having linear ether groups and/or branched ether groups of the following general formulas (V) to (VII):
   —O—(CH₂)ₓ— (V), where x=2 to 10, preferably 2 to 6, more preferably 2 to 4,
   —O—CR³R⁴—CH₂— (VI), where R³ and R⁴ are independent of one another and are hydrogen or an aliphatic linear or branched, saturated or unsaturated radical having up to 10 carbon atoms, which may also include oxygen atoms, or an aromatic radical having up to 10 carbon atoms, but where at least one of the radicals R³ or R⁴ is not hydrogen, and
   —O—CR⁵R⁶—CR⁷R⁸— (VII), where R⁵ to R⁸ are independent of one another and where R⁵ and R⁷ are hydrogen or an aliphatic linear or branched, saturated or unsaturated radical having up to 10 carbon atoms, which may also include oxygen atoms, and R⁶ and R⁸ are an aliphatic linear or branched, saturated or unsaturated radical having up to 10 carbon atoms, which may also include oxygen atoms, or R⁶ and R⁸ are joined to one another so as to form a saturated or unsaturated ring having up to 8 carbon atoms that may be substituted with organic radicals,
B3) optionally at least one polyol different from B2,
C) optionally one or more isocyanate-reactive components that are different from A,
D) optionally one or more isocyanate components different from B, selected from the group comprising D1) modified polyisocyanates obtainable from the reaction of monomeric polyisocyanates with polyols and D2) isocyanate components different from D1,
E) -E1) optionally auxiliaries and/or additives, excluding those of components E2 and E3,
E2) optionally inorganic fillers and/or inorganic pigments,
and/or
E3 optionally solvents,
where Gₓ is defined as
   the total amount of
      polyether polyamines of the formula III incorporated into the polyaspartic esters of the polyaspartic-ester-containing component A,
      polyether polyols B2 and polyols B3 incorporated into the polyurethane prepolymers B,
      polyols and polyether polyamines coming under component C, and
      polyols incorporated into the modified polyisocyanates D1,
   based on the total weight of the components A to E1, and G_{F} is defined as
   the total amount of components A to D having a functionality of >2 based on 1 kg of components A to E1,
   where the functionality comprises the isocyanate groups and isocyanate-reactive groups, and where:
i) when component B2 comprises ≤100 to ≥70 percent by weight of linear ether groups and ≥0 to ≤30 percent by weight of branched ether groups, in each case based on the total amount of linear and branched ether groups in component B2,
   then Gₓ is ≥35 to ≤72 percent by weight and G_{F} is ≥0 to <0.09 mol/kg, and
ii) when component B2 comprises ≥0 to <70 percent by weight of linear ether groups and ≤100 to >30 percent by weight of branched ether groups, in each case based on the total amount of linear and branched ether groups in component B2, and
   ii₁) G_{F} is ≥0 to <0.05 mol/kg, then Gₓ is ≥35 to <50 percent by weight, or
   ii₂) G_{F} is ≥0.05 to <0.09 mol/kg, then Gₓ is ≥35 to ≤65 percent by weight.

With regard to the abovementioned embodiment i), the following preferred ranges apply:
Preferably, Gx is ≥35 to ≤72 percent by weight and G_{F} is ≥0 to ≤0.08 mol/kg, preferably ≥0 to ≤0.05 mol/kg.
More preferably, Gx is ≥40 to ≤68 percent by weight and G_{F} is ≥0 to <0.09 mol/kg, preferably ≥0 to ≤0.08 mol/kg, more preferably ≥0 to ≤0.05 mol/kg.
Most preferably, Gx is ≥50 to ≤65 percent by weight and G_{F} is ≥0 to <0.09 mol/kg, preferably ≥0 to ≤0.08 mol/kg, more preferably ≥0 to ≤0.05 mol/kg.

With regard to the abovementioned embodiment ii₂), the following preferred ranges apply:
Preferably, G_{F} is ≥0.05 to <0.08 mol/kg and Gₓ is ≥35 to ≤65 percent by weight.

In the context of the present invention, the term “linear” means “unbranched” and the term “linear aliphatic” means “open-chain aliphatic”.

Linear ether groups are thus unbranched ether groups, for example those having n-propylene units. These contrast with branched ether groups, for example those having isopropylene units. Aliphatic linear radicals are thus aliphatic unbranched radicals such as n-propylene radicals. These contrast with aliphatic branched radicals, such as isopropylene radicals.

Open-chain aliphatic radicals are referred to as linear aliphatic. These can be branched or unbranched.

The present invention also provides two-component coating compositions (2K coating compositions) consisting of components A to E.

The amount of polyether polyols B2 and polyols B3 incorporated into the polyurethane prepolymers B, or of polyols incorporated into the modified polyisocyanates D1, is to be determined in each case as follows:

Where the components B and D1 are monomer-free linear compounds, i.e. monomer-free compounds based on unbranched polyether polyols or polyols, this is done according to Flory (P. J. Flory, “Molecular Size Distribution in Linear Condensation Polymers”, JACS 1936, pp. 1877-1885). Where the components B and D1 are monomer-free branched compounds, i.e. monomer-free compounds based on branched polyether polyols or polyols, this is done by simulation in accordance with WO 2021/055398 A1. In the case of compounds that are not monomer-free, it is determined by calculation from the respective formulation of the manufacturing procedure.

The content of polyether polyols and polyetheramines based on the total weight of components A1 to E1 in the coating composition can also be determined experimentally via quantitative deuterated digestion with ¹H-NMR analysis. For this, approx. 100 mg of sample is weighed into a test tube together with approx. 20 mg of naphthalene internal standard. The digestion reagent used is 2 ml of deuterated sodium hydroxide solution in deuterated methanol. The test tube is then flame-sealed and left overnight in an oven at 150° C. The next day, a portion of the solution is transferred to an NMR tube and measured by ¹H NMR (400 MHz, 256 scans). For the quantitative evaluation of the measurement, the structural units specific to the respective polyether are integrated and used to calculate the content. Account must be taken of the corresponding proton ratio and it should be noted that this relates to structural units/repeat units of the polyether.

The amount of polyether polyamines of the formula III incorporated into the polyaspartic esters of the polyaspartic-ester-containing component A is calculated from the formulation of the manufacturing procedure (example: PAE-D230 described in RSC Adv., 2018, 8, 13474 is produced from 115 g of the polyetheramine Jeffamine D230 and 172.18 g of diethyl maleate, consequently the product contains 40% polyetheramine.) When secondary components are removed, for example by distillation, this is likewise taken into account.

### Polyaspartic-Ester-Containing Component a

The at least one polyaspartic-ester-containing component A preferably comprises one or more polyaspartic esters of the general formulas (I) and optionally (II) in which R1 and R2 are identical or different alkyl radicals each having 1 to 18 carbon atoms, preferably identical or different alkyl radicals each having 1 to 8 carbon atoms, and most preferably in each case alkyl radicals such as methyl, ethyl, propyl, isopropyl, butyl or isobutyl radicals. Most preferred is ethyl.

The at least one polyaspartic-ester-containing component A comprises one or more polyaspartic esters of the general formulas (I) and optionally (II) in which X represents organic radicals obtained by removing the primary amino groups from a corresponding polyamine or polyetheramine having (cyclo)aliphatically or araliphatically attached primary amino groups, selected from the following group: all known polyamines or polyetheramines having primary amino groups that conform to the general formula (III). Examples of polyamines include the following compounds: ethylenediamine, 1,2-diaminopropane, 1,4-diaminobutane, 1,5-diaminopentane, 2,5-diamino-2,5-dimethylhexane, 1,5-diamino-2-methylpentane (Dytek® A, from DuPont), 1,6-diaminohexane, 2,2,4- and/or 2,4,4-trimethyl-1,6-diaminohexane, 1,11-diaminoundecane, 1,12-diaminododecane or triaminononane, aliphatic polycyclic polyamines, such as tricyclodecanebismethylamine (TCD diamine) or bis(aminomethyl)norbornane, amino-functional siloxanes, for example diaminopropylsiloxane G10 DAS (from Momentive), fatty alkyl-based amines, for example Fentamine from Solvay, dimer fatty acid diamines, for example Priamine from Croda. Examples of polyether polyamines include: 4,9-dioxadodecane-1,12-diamine, 4,7,10-trioxatridecane-1,13-diamine, and higher-molecular-weight polyether polyamines having aliphatically attached primary amino groups, for example those sold under the Jeffamine® name by Huntsman.

Preferably, the at least one polyaspartic-ester-containing component A comprises one or more polyaspartic esters of the general formulas (I) and optionally (II) in which X represents organic radicals obtained by removing the primary amino groups from one of the polyamines of the general formula (III) in which m=2 and X is a cyclic hydrocarbon radical having at least one cyclic carbon ring. Examples of diamines that may be used with particular preference are 1-amino-3,3,5-trimethyl-5-aminomethylcyclohexane (IPDA), 2,4- and/or 2,6-hexahydrotolylenediamine (H6-TDA), isopropyl-2,4-diaminocyclohexane and/or isopropyl-2,6-diaminocyclohexane, 1,3-bis(aminomethyl)cyclohexane, 2,4′-, and/or 4,4′-diaminodicyclohexylmethane, 3,3′-dimethyl-4,4′-diaminodicyclohexylmethane (Laromin® C 260, BASF AG), the isomeric diaminodicyclohexylmethanes substituted in the ring with a methyl group (=C-monomethyl-diaminodicyclohexylmethanes), 3(4)-aminomethyl-1-methylcyclohexylamine (AMCA) and also araliphatic diamines such as 1,3-bis(aminomethyl)benzene or m-xylylenediamine.

Likewise preferably, the at least one polyaspartic-ester-containing component A comprises one or more polyaspartic esters of the general formulas (I) and optionally (II) in which X represents organic radicals obtained by removing the primary amino groups from one of the polyamines or polyether polyamines of the general formula (T11) selected from the group: polyether polyamines having aliphatically attached primary amino groups, 1,2-diaminopropane, 1,4-diaminobutane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 1,5-diaminopentane, 2,4′- and/or 4,4′-diaminodicyclohexylmethane or 3,3′-dimethyl-4,4′-diaminodicyclohexylmethane. Particular preference is given to 3,3′-dimethyl-4,4′-diaminodicyclohexylmethane, 1,5-diaminopentane, 2,4′- and/or 4,4′-diaminodicyclohexylmethane, 1,5-diamino-2-methylpentane, and very particular preference to using 2,4′- and/or 4,4′-diaminodicyclohexylmethane.

More preferably, the at least one polyaspartic-ester-containing component A comprises one or more polyaspartic esters of the general formulas (I) and optionally (II) in which X represents organic radicals obtained by removing the primary amino groups from one of the polyamines or polyether polyamines of the general formula (III) selected from the group: polyether polyamines having aliphatically attached primary amino groups, 1,2-diaminopropane, 1,4-diaminobutane, 1,5-diaminopentane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′- and/or 4,4′-diaminodicyclohexylmethane or 3,3′-dimethyl-4,4′-diaminodicyclohexylmethane.

The at least one polyaspartic-ester-containing component A most preferably comprises one or more polyaspartic esters of the general formulas (I) and optionally (II) in which X represents organic radicals obtained by removing the primary amino groups from one of the polyamines of the general formula (III) selected from the group: 3,3′-dimethyl-4,4′-diaminodicyclohexylmethane, 2,4′- and/or 4,4′-diaminodicyclohexylmethane, and 1,5-diamino-2-methylpentane.

The index m is an integer ≥1 and preferably 2.

Where the at least one polyaspartic-ester-containing component A comprises one or more polyaspartic esters of the general formula (II), this/these is/are present in a proportion of >0%, preferably not less than 0.1% (≥0.1%), more preferably not less than 1% (≥1%), most preferably not less than 4% (≥4%), and preferably not more than 20% (≤20%), more preferably not more than 15% (≤15%), of the area by GC (measured as area % in the gas chromatogram), where the sum of the areas by GC of compounds of the two general formulas (I) and (II) is 100%. Any combination of the specified upper and lower limits is possible. All possible combinations are considered disclosed.

The at least one polyaspartic-ester-containing component A preferably comprises one or more polyaspartic esters of the general formulas (I) and optionally (II), where the esters have a platinum-cobalt color index of ≤200, more preferably of ≤100. The platinum-cobalt color index is measured in accordance with DIN EN ISO 6271:2016-05.

The polyaspartic-ester-containing components A to be used according to the invention can be prepared by the following process:

Reaction of polyamines or polyether polyamines of the general formula (III),

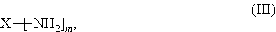

where X
is an m-valent organic radical, optionally containing one or more heteroatoms, as can be obtained by removing the primary amino groups from a polyamine or polyether polyamine that has (cyclo)aliphatically or araliphatically attached primary amino groups and is in the ≥60 to ≤6000 g/mol molecular weight range and that may contain further functional groups reactive toward isocyanate groups and/or functional groups inert at temperatures of up to 100° C., and
m is an integer >1, preferably 2,
   with compounds of the general formula (IV)

R¹OOC≡CH═CH—COOR² (IV),
where R1 and R2
are identical or different organic radicals, preferably identical or different alkyl radicals each having 1 to 18 carbon atoms, more preferably identical or different alkyl radicals each having 1 to 8 carbon atoms, most preferably in each case alkyl radicals such as methyl, ethyl, propyl, isopropyl, butyl or isobutyl radicals and most preferably ethyl,
   and removal by distillation of the excess fraction of the compound of the general formula (IV).

In the first step, the compounds of the general formula (III) and (IV) are reacted at temperatures of between 0° C. and 100° C., preferably 20 to 80° C., and more preferably 20 to 60° C., in a ratio of equivalents of primary amino groups in the compounds of the general formula (III) to C═C double bond equivalents in the compounds of the general formula (IV) of 1:1.2 to 1.2:1, but preferably 1:1.05 to 1.05:1, more preferably 1:1, until the residual content of compounds of the general formula (IV) is from 2 to 15 percent by weight, preferably from 3 to 10 percent by weight.

Polyaspartic-ester-containing components A that comprise only polyaspartic esters of the general formula (I), but not of the formula (II), or that are virtually free of polyaspartic esters of the general formula (II), can be prepared in analogous manner, but employing an excess of compounds of the general formula (IV), i.e. in a ratio of equivalents of primary amino groups in the compounds of the general formula (III) to C═C double bond equivalents in the compounds of the general formula (IV) of 1:10, preferably 1:5, more preferably 1:2.

The reaction is followed by a distillation step in which the excess of compounds of the general formula (IV) is removed.

Suitable conditions during the distillation are a pressure range of between 0.01 and 2 mbar and a temperature in the bottom outflow on exiting the distillation apparatus of ≤170° C. and ≥ the temperature resulting from the following formula (VIII):

$$T ( bottom outflow ) = 27 \times ln ( p ) + 150 {where T ( bottom outflow )}_{p} is the temperature of the bottom outflow in ° C . and is the pressure in the distillation apparatus in mbar . \qquad ( VIII )$$

Keeping within this pressure range ensures that moderate temperatures in the bottom outflow are sufficient for depletion of the compounds of the general formula (IV) to the desired extent, while ensuring the process remains employable on an industrial scale. At lower pressure, the gas density becomes too low and the necessary apparatus consequently so large that the process becomes economically disadvantageous.

The temperature of the bottom outflow is preferably ≤170° C., but at least 20 K above the temperature resulting from formula (VIII); more preferably it is between 20 K and 40 K above the temperature resulting from formula (VIII), but not higher than 170° C.

During the preparation of polyaspartic esters based on maleic esters as compounds of formula (IV), a retro-Michael addition can occur as an undesired side reaction in which elimination of the polyamine results in the formation of the corresponding dialkyl fumarates as secondary components. These cause sensitization. They count as compounds of the formula (IV) and are removed in the distillation step or their content is significantly reduced by the distillation.

Where the polyaspartic-ester-containing component A contains dialkyl fumarates, these are present in amounts of >0% to ≤3% by weight, preferably ≥0.01% to ≤1.5% by weight, more preferably ≥0.01% to ≤1% by weight, most preferably ≥0.01% to ≤0.5% by weight, based on the total weight of component A.

With regard to examples and preferred ranges of the polyamines of the general formula (III) that may be used in the process described above, reference is made to the preceding statements.

Preferred compounds of the general formula (IV) that are used in the process described above are maleic or fumaric esters of the general formula (IV) in which R1 and R2 are identical or different organic radicals each having 1 to 18 carbon atoms. Preferably, R¹ and R² are independently linear or branched alkyl radicals having 1 to 8 carbon atoms, more preferably each alkyl radicals such as methyl, ethyl, propyl, isopropyl, butyl or isobutyl radicals, and most preferably ethyl. Examples of compounds of the general formula (IV) include the following compounds: dimethyl maleate, diethyl maleate, di-n-propyl or diisopropyl maleate, di-n-butyl maleate, di-2-ethylhexyl maleate or the corresponding fumaric esters. Very particular preference is given to diethyl maleate.

### Component B

The two-component coating compositions of the invention comprise as component B at least one NCO-functional polyurethane prepolymer obtainable by reacting
B1) at least one polyisocyanate with
B2) at least one polyether polyol, and
B3) optionally at least one polyol different from B2.

Polyisocyanates B1 suitable for preparing the NCO-functional polyurethane prepolymers have a functionality preferably of ≥2.

Polyisocyanates B1 suitable for preparing the NCO-functional polyurethane prepolymers are, for example, monomeric polyisocyanates. These include any monomeric diisocyanates obtainable via phosgenation in the liquid or gas phase or by phosgene-free routes. Preferred diisocyanates are those in the 140 to 400 g/mol molecular weight range having linear-aliphatically, cycloaliphatically, araliphatically and/or aromatically attached isocyanate groups, for example 1,4-diisocyanatobutane, 1,5-diisocyanatopentane (pentamethylene diisocyanate, PDI), 1,6-diisocyanatohexane (hexamethylene diisocyanate, HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanatomethylcyclohexane, bis(isocyanatomethyl)norbornane, 1,3- and 1,4-bis(isocyanatomethyl)benzene (xylylene diisocyanate, XDI), 1,3- and 1,4-bis(2-isocyanatoprop-2-yl)benzene (tetramethylxylylene diisocyanate, TMXDI), 2,4- and 2,6-diisocyanatotoluene (tolylene diisocyanate, TDI), 2,4′- and 4,4′-diisocyanatodiphenylmethane (MDI), 1,5-diisocyanatonaphthalene or mixtures of at least two such diisocyanates. An example of a monomeric polyisocyanate having an NCO functionality of >2 is triisocyanatononane (TIN).

Particularly preferred diisocyanates are those in the 140 to 400 g/mol molecular weight range having linear-aliphatically, cycloaliphatically and/or araliphatically attached isocyanate groups, very particularly preferably ones having linear-aliphatically and/or cycloaliphatically attached isocyanate groups, even more preferably ones having linear-aliphatically attached isocyanate groups. Most preferably, these are PDI and/or HDI.

Further suitable polyisocyanates B1 for the preparation of the NCO-functional polyurethane prepolymers are linear aliphatic, cycloaliphatic, araliphatic, and aromatic polyisocyanates with an NCO functionality of ≥2 and having uretdione, isocyanurate, allophanate, urea, biuret, iminooxadiazinedione and/or oxadiazinetrione structures (hereinafter also referred to as modified polyisocyanates). These can be obtained from monomeric polyisocyanates having an NCO functionality of ≥2 of the type described above. Their synthesis is described by way of example in, for example, J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053, and DE-A 3 928 503 or in EP-A 0 336 205, EP-A 0 339 396, and EP-A 0 798 299 and in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915, and in JP 56059828.

In the preparation of these modified polyisocyanates B1, the actual modification reaction with uretdione, isocyanurate, allophanate, urea, biuret, iminooxadiazinedione and/or oxadiazinetrione structures is generally followed by a further process step for removing the unreacted excess monomeric isocyanates. The monomers are removed by processes known per se, preferably by thin-film distillation under high vacuum or by extraction with suitable solvents inert to isocyanate groups, for example aliphatic or cycloaliphatic hydrocarbons such as pentane, hexane, heptane, cyclopentane or cyclohexane. Preferably, the modified polyisocyanates thus obtainable have a content of monomeric isocyanates of less than 0.5% by weight, more preferably of less than 0.3% by weight. The residual monomer contents are measured according to DIN EN ISO 10283:2007-11 by gas chromatography with an internal standard.

Preferred modified polyisocyanates B1 are those with an NCO functionality of ≥2 and having uretdione, isocyanurate, allophanate, urea, biuret, iminooxadiazinedione and/or oxadiazinetrione structures with exclusively linear-aliphatically and/or cycloaliphatically attached isocyanate groups. Particular preference is given to polyisocyanates with an NCO functionality of ≥2 and having an isocyanurate and/or allophanate structure that has exclusively linear-aliphatically and/or cycloaliphatically attached isocyanate groups, preferably ones based on PDI, HDI, IPDI and/or 4.4′-diisocyanatodicyclohexylmethane. Most preferred are polyisocyanates with an NCO functionality of ≥2 and having an isocyanurate and/or allophanate structure that has exclusively linear-aliphatically attached isocyanate groups, preferably ones based on PDI or HDI.

In principle, it is of course also possible to use mixtures of different polyisocyanates of the type mentioned above.

The polyether polyols B2 suitable for preparing the NCO-functional polyurethane prepolymers preferably have number-average molecular weights Mn of from ≥200 to ≤10 000 g/mol, more preferably from ≥400 to ≤2500 g/mol, and an average hydroxyl functionality preferably of from ≥1.8 to ≥6, more preferably from ≤1.9 to ≤2.1 g/mol, most preferably from ≥1.9 to ≤2 g/mol.

Suitable polyether polyols B2 have linear ether groups and/or branched ether groups of the following general formulas (V) to (VII):
i) —O—(CH₂)ₓ— (V), where x is 2 to 10, preferably 2 to 6, more preferably 2 to 4.
ii) —O—CR³R⁴—CH₂— (VI), where R³ and R⁴ are independent of one another and are hydrogen or an aliphatic linear or branched, saturated or unsaturated radical having up to 10 carbon atoms, which may also include oxygen atoms, or an aromatic radical having up to 10 carbon atoms, but where at least one of the radicals R³ or R⁴ is not hydrogen.

Preferably, R³ and R⁴ are independent of one another and are hydrogen or an aliphatic linear or branched, saturated or unsaturated radical having up to 10 carbon atoms, but where at least one of the radicals R³ or R⁴ is not hydrogen.

Particularly preferably, R³ is hydrogen and R⁴ is an aliphatic linear or branched, saturated or unsaturated radical having up to 10 carbon atoms, preferably 6 carbon atoms.
iii) —O—CR⁵R⁶—CR⁷R⁸— (VII), where R⁵ to R⁸ are independent of one another and where R⁵ and R⁷ are hydrogen or an aliphatic linear or branched, saturated or unsaturated radical having up to 10 carbon atoms, which may also include oxygen atoms, and R⁶ and R⁸ are an aliphatic linear or branched, saturated or unsaturated radical having up to 10 carbon atoms, which may also include oxygen atoms, or R⁶ and R⁸ are joined to one another so as to form a saturated or unsaturated ring having up to 8 carbon atoms that may be substituted with organic radicals.

Preferably, R⁵ to R⁸ are independent of one another and R⁵ and R⁷ are hydrogen and R⁶ and R⁸ are an aliphatic linear or branched, saturated or unsaturated radical having up to 10 carbon atoms, preferably 6 carbon atoms.

Suitable polyether polyols B2 are obtainable for example by ring-opening polymerization of cyclic ethers in the presence of hydroxy-functional compounds.

Suitable hydroxy-functional compounds are preferably water or those having an OH functionality of ≥2 to ≤6, for example propylene glycol, propane-1,3-diol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, triethanolamine, pentaerythritol, sorbitol, sucrose, hydroquinone, catechol, resorcinol, bisphenol F, bisphenol A, 1,3,5-trihydroxybenzene or methylol-group-containing condensates of formaldehyde and phenol. These may also be used in mixtures. Preference is given to polyols selected from the group propylene glycol, propane-1,3-diol, glycerol, trimethylolpropane, and pentaerythritol.

Cyclic ethers suitable for preparing the polyether polyols B2 are for example the following compounds: ethylene oxide, propylene oxide, 1,2-butylene oxide, 2,3-butylene oxide, 2-methyl-1,2-propylene oxide (isobutylene oxide), 1,2-pentylene oxide, 2,3-pentylene oxide, 2-methyl-1,2-butylene oxide, 3-methyl-1,2-butylene oxide, 1,2-hexylene oxide, 2,3-hexylene oxide, 3,4-hexylene oxide, 2-methyl-1,2-pentylene oxide, 4-methyl-1,2-pentylene oxide, 2-ethyl-1,2-butylene oxide, 1,2-heptylene oxide, 1,2-octylene oxide, 1,2-nonylene oxide, 1,2-decylene oxide, 1,2-undecylene oxide, 1,2-dodecylene oxide, 4-methyl-1,2-pentylene oxide, butadiene monoxide, isoprene monoxide, cyclopentene oxide, cyclohexene oxide, cycloheptene oxide, cyclooctene oxide, styrene oxide, methylstyrene oxide, pinene oxide, derivatives of glycidol, for example methyl glycidyl ether, ethyl glycidyl ether, 2-ethylhexyl glycidyl ether, allyl glycidyl ether, trimethylene oxide, tetramethylene oxide (THF), pentamethylene oxide, hexamethylene oxide, heptamethylene oxide, and decamethylene oxide. Copolymerization of two or more of these ethers is also possible.

Preferably, the polyether polyols B2 are based on ethylene oxide, propylene oxide and/or tetramethylene oxide (THF), more preferably on propylene oxide and/or tetramethylene oxide (THF).

The synthesis of polyether polyols of the type mentioned above is described in detail in, for example, DE 26 22 951 B, column 6, line 65 to column 7, line 26, in EP-A 0 978 523, page 4, line 45 to page 5, line 14, and in WO 2011/069966, page 4, line 20 to page 5, line 23. Syntheses are known in which the ring-opening polymerization is acid-catalyzed, for example for the preparation of poly-THF. Detailed descriptions can be found for example in Angew. Chem. 72, 927 (1960).

For the preparation of the NCO-functional polyurethane prepolymers, it is possible to employ further polyols (B3) different from B2.

These may for example be low-molecular-weight polyols in the 62 to 300 g/mol molecular weight range, for example ethylene glycol, propylene glycol, trimethylolpropane, glycerol or mixtures of these alcohols, or polyhydroxy compounds having a molecular weight of above 300 g/mol, preferably above 400 g/mol, more preferably between 400 and 20 000 g/mol. Such polyhydroxyl compounds are in particular those having 2 to 6, preferably 2 to 3, hydroxyl groups per molecule and are selected from the group consisting of polyester polyols, polythioether polyols, polyurethane polyols, polycarbonate polyols, and polyacrylate polyols.

For the preparation of the NCO-functional polyurethane prepolymers, an NCO/OH equivalents ratio of 1.5:1 to 20:1 is observed in the reaction of the polyisocyanate(s) B1, the polyether polyol(s) B2, and optionally the polyol(s) B3 to form urethanes. The reaction takes place at temperatures of 20 to 200° C., preferably 40 to 140° C., more preferably 50 to 120° C. When using the polyisocyanate in an excess of more than 2:1, it is preferable that excess monomeric polyisocyanate is removed through standard prior art distillation or extraction methods (for example thin-film distillation) after the reaction.

The reaction may be accelerated through the use of a catalyst that accelerates urethane formation. Examples of customary catalysts are organotin compounds, bismuth compounds, zinc compounds, titanium compounds, zirconium compounds or aminic catalysts. Where one or more catalysts are employed, the amount used is preferably 0.001% to 5% by weight, especially 0.002% to 2% by weight, of catalyst or catalyst combination, based on the total weight of the prepolymer mixture.

The reaction may be carried out using a solvent or solvent mixture. Examples of customary solvents are those described below under “Auxiliaries and additives (components E)” for the preparation of the two-component coating composition of the invention. Reference is made here to the list there.

The proportion of the polyether polyols B2 is at least 30 percent by weight, preferably at least 40 percent by weight, more preferably at least 60 percent by weight, based on the total weight of component B.

Preferably, the polyurethane prepolymers have an average NCO functionality of ≥1.8, preferably from ≥2 to ≤2.3.

### Components C

In addition to the polyaspartic-ester-containing component A, the two-component composition of the invention may comprise further components reactive toward isocyanate groups.

These may for example be low-molecular-weight polyols in the 62 to 300 g/mol molecular weight range, for example ethylene glycol, propylene glycol, trimethylolpropane or glycerol.

They may also be polyols having a molecular weight of more than 300 g/mol, preferably more than 400 g/mol, more preferably having a molecular weight between 400 and 20 000 g/mol. Such polyols are in particular those having 2 to 6, preferably 2 to 3, hydroxyl groups per molecule and are selected from the group consisting of polyester polyols, polyether polyols, polythioether polyols, polyurethane polyols, polycarbonate polyols, and polyacrylate polyols.

Useful compounds reactive toward isocyanate groups also include for example polyamines or polyether polyamines. Particularly suitable polyamines are those having at least two primary amino groups per molecule and optionally also secondary amino groups and preferably having an average molecular weight of 60 to 500. Suitable examples are ethylenediamine, 1,2- and 1,3-diaminopropane, 1,4-diaminobutane, 2,2,4- and/or 2,4,4-trimethylhexamethylenediamine, the isomeric xylylenediamines, 1,4-diaminocyclohexane, 4,4′-diaminodicyclohexylmethane, 1,3-diaminocyclopentane, 4,4′-diaminodicyclohexyl sulfone, 4,4′-diamino-1,3-dicyclohexylpropane, 4,4′-diamino-2,2-dicyclohexylpropane, 3,3′-dimethyl-4,4′-diaminodicyclohexylmethane, 3-aminomethyl-3,3,5-trimethylcyclohexylamine (isophoronediamine), 3(4)-aminomethyl-1-methylcyclohexylamine, technical grade bisaminomethyltricyclodecane, octahydro-4,7-methanoindene-1,5-dimethanamine, or also polyamines that, in addition to at least two primary amino groups, also have secondary amino groups, for example diethylenetriamine or triethylenetetramine. Especially suitable polyether polyamines are polyether polyamines having aliphatically attached primary amino groups, for example those marketed by Huntsman under the Jeffamine® trade name.

### Isocyanate Components D

Suitable as isocyanate component D (different from B) are for example monomeric polyisocyanates (component D2). With regard to the description of suitable monomeric polyisocyanates, reference is made to the statements on the monomeric polyisocyanates under component B1. These apply by analogy here, including the preferred ranges stated above.

Also suitable as isocyanate component D are modified polyisocyanates, i.e. linear aliphatic, cycloaliphatic, araliphatic, and aromatic polyisocyanates with an NCO functionality of ≥2 and having uretdione, isocyanurate, urethane, allophanate, urea, biuret, iminooxadiazinedione and/or oxadiazinetrione structures. These can be obtained from monomeric polyisocyanates having an NCO functionality of ≥2 of the type described above. Polyisocyanates modified with urethane and/or allophanate structures are based on reaction of the monomeric polyisocyanates preferably with polyester polyols, polythioether polyols, polyurethane polyols, polycarbonate polyols, and/or polyacrylate polyols and are encompassed by component D1). Modified polyisocyanates that do not have urethane and/or allophanate structures are encompassed by component D2).

With regard to the synthesis and processing of the modified polyisocyanates, reference is made to the statements under component B1. These apply by analogy here.

Preferred modified polyisocyanates are those with an NCO functionality of ≥2 and having uretdione, isocyanurate, urethane, allophanate, urea, biuret, iminooxadiazinedione and/or oxadiazinetrione structures with exclusively linear-aliphatically and/or cycloaliphatically attached isocyanate groups. Particular preference is given to polyisocyanates with an NCO functionality of ≥2 and having an isocyanurate, urethane and/or allophanate structure that has exclusively linear-aliphatically and/or cycloaliphatically attached isocyanate groups, preferably ones based on PDI, HDI, IPDI and/or 4.4′-diisocyanatodicyclohexylmethane. Most preferred are polyisocyanates with an NCO functionality of ≥2 and having an isocyanurate, urethane and/or allophanate structure that has exclusively linear-aliphatically attached isocyanate groups, preferably ones based on PDI or HDI.

### Components E1 and E2

E1 encompasses for example organic pigments, fillers or fibers, for example indigo, PTFE particles or Kevlar fibers. Inorganic pigments and fillers, for example titanium dioxide, zinc oxide, iron oxides, chromium oxides, carbon black, baryte, chalk, wollastonite or talc, are encompassed by component E2. A comprehensive review of pigments and fillers for coatings is given in “Lehrbuch der Lacke und Beschichtungen [Textbook on paints and coatings], volume II, “Pigmente, Füllstoffe, Farbstoffe” [Pigments, fillers, dyes], H. Kittel, Verlag W. A. Colomb in der Heenemann GmbH, Berlin-Oberschwandorf, 1974, pp. 17-265.

The auxiliaries and additives E1 also include catalysts/activators such as titanium-, zirconium-, bismuth-, tin- and/or iron-containing catalysts, as described for example in WO 05058996. It is also possible to add amines or amidines.

Examples of further suitable auxiliaries and additives E1 are coatings additives, for instance light stabilizers such as UV absorbers and sterically hindered amines (HALS), and also stabilizers, defoaming agents, anticratering and/or wetting agents, leveling agents, film-forming auxiliaries, reactive diluents, biocides, solvents or substances for rheology control. The use of light stabilizers, especially of UV absorbers, for example substituted benzotriazoles, S-phenyltriazines or oxalanilides, and of sterically hindered amines, especially those having a 2,2,6,6-tetramethylpiperidyl structure—referred to as HALS—is described by way of example in A. Valet, Lichtschutzmittel für Lacke [Light stabilizers for paints], Vincentz Verlag, Hanover, 1996.

Stabilizers, for example free-radical scavengers and other polymerization inhibitors such as sterically hindered phenols, stabilize paint components during storage and are intended to prevent discoloration during curing. Wetting and leveling agents improve surface wetting and/or the leveling of paints. Examples are fluorosurfactants, silicone surfactants, and specific polyacrylates. Rheology-control additives are important in order to control the properties of the two-component system on application and in the leveling phase on the substrate and are disclosed for example in patent specifications WO 9422968, EP0276501, EP0249201 or WO 9712945. It is additionally possible to employ water scavengers, for example triethyl orthoformate, toluenesulfonyl isocyanate, monooxazolidines or molecular sieves, and hydrolysis stabilizers, for example carbodiimides. A comprehensive review of coatings additives is given in “Lehrbuch der Lacke und Beschichtungen [Textbook on paints and coatings], volume III, “Lösemittel, Weichmacher, Additive, Zwischenprodukte” [Solvents, plasticizers, additives, intermediates], H. Kittel, Verlag W. A. Colomb in der Heenemann GmbH, Berlin-Oberschwandorf, 1976, pp. 237-398.

### Solvent (Component E3)

The solvent may be an organic solvent or a mixture of organic solvents. Suitable solvents should be used in a manner known to those skilled in the art that is tailored to the composition and to the method of application. The purpose of solvents is to dissolve the components used and to promote their mixing and also to avoid incompatibilities. In addition, during application and curing, they should escape from the coating in a manner tailored to the crosslinking reaction in progress so as to afford a solvent-free coating of optimal appearance and free of defects such as popping or pinholes. Suitable solvents include in particular those used in two-component technology. Examples of organic solvents are ketones, such as acetone, methyl ethyl ketone or hexanone, esters, such as ethyl acetate, butyl acetate or methoxypropyl acetate, substituted glycols and other ethers, aromatics, such as xylene or solvent naphtha, for example from Exxon-Chemie, and mixtures of the solvents mentioned. When the NCO-reactive component of the composition is in the form of an aqueous dispersion, water is also suitable as solvent or diluent.

The ratio of the molar amounts of the isocyanate groups from B and D and of the NCO-reactive groups from A and C in the coating composition is preferably from 0.5:1.0 to 3.0:1.0. Particular preference is given to a ratio of from 0.9:1.0 to 1.5:1.0. Very particular preference is given to a ratio of from 0.99:1.0 to 1.2:1.0

Where isocyanate-reactive components C that are different from A are present in the coating composition, the proportion thereof is not more than 75 percent by weight, preferably not more than 50 percent by weight, based on the total weight of components A to E2.

Where isocyanate components D that are different from B are present in the coating composition, the proportion thereof is not more than 50 percent by weight, preferably not more than 30 percent by weight, based on the total weight of components A to E2.

Where auxiliaries and/or additives (component E1) and/or inorganic fillers and/or inorganic pigments (component E2) are present in the coating composition, the proportion thereof is not more than 60 percent by weight, preferably not more than 25 percent by weight, more preferably not more than 10 percent by weight, based on the total weight of components A to E2.

Where solvents (component E3) are present in the coating composition, the proportion thereof is not more than 50 percent by weight, preferably not more than 25 percent by weight, based on the total weight of components A to E3.

The two-component compositions of the invention are preferably not foamable or foam-forming compositions. The compositions are preferably not polymerizable by free radicals, especially not photopolymerizable, i.e. the compositions do not cure through free-radical processes, especially not through free-radical polymerization processes initiated by actinic radiation.

The two-component coating compositions of the invention are produced by methods known per se in paint technology.

An isocyanate-reactive (R) and an isocyanate-containing component (H) are first produced separately by mixing the respective isocyanate-reactive components A and C and by mixing the respective polyisocyanate components B and D. The auxiliaries and additives E are preferably admixed with the isocyanate-reactive component R. The components R and H thus produced are not mixed together until immediately before or during application. When mixing takes place before application, it should be noted that the reaction of the constituents commences immediately after mixing. The rate of the reaction varies according to the choice of components and additives. The processing time within which the composition must be applied is also known as the pot life and is defined as the time from mixing of the components until doubling of the flow time; depending on the choice of components, this is in the range from 1 minute to 24 hours, usually in the range from 10 minutes to 8 hours. The pot life is determined by methods known to those skilled in the art.

The invention also relates to a process for producing a coating on a substrate comprising at least the following steps:
i) applying a two-component coating composition as described above to at least part of a substrate to be coated and
ii) curing the coating composition from step i).

The substrates may have already been coated entirely or partly with one or more coating layers. These coating layers may still be uncured or wet, partially cured or fully cured; preferably, the further coating layers on the substrate are partially cured or fully cured. Examples of coating layers are priming coats, primers, fillers, spackling coats, basecoats, or substrates that have already been fully painted and are being recoated after possible pretreatment such as sanding or plasma activation.

The two-component coating compositions are used in particular for the production of protective coatings, especially for objects exposed to (repeated) mechanical stresses, for example for rotor blades of wind turbines or helicopters, for aircraft wings, and ship propellers. The entire surface of such a component may be coated here. It is also possible to coat only areas of the surface of the component, for example the leading edge of a rotor blade, of an aircraft wing or of a ship propeller.

The present invention accordingly further provides preferably for the use of the two-component coating compositions described above for producing coatings on substrates, the process described above for coating substrates with these coatings, and the coated substrates themselves that are obtainable in this way.

The coating composition may be applied by customary application methods. Examples of application methods are brushing and rolling, roller application, knife application, dipping and spraying. An optional flash-off time is followed by the curing and drying of the composition of the invention on the substrate or object. This is carried out according to methods that are customary in coating technology, either under ambient conditions (temperature and atmospheric humidity) or under forced conditions, for example by raising the oven temperature, using radiation such as infrared, near-infrared or microwave radiation, or using dehumidified and/or heated air or other gases. This is preferably done without using devices for forced curing. The applied coating composition is for example cured at temperatures of from −20 to 100° C., preferably from −10 to 80° C., more preferably from 0 to 60° C., and most preferably from 10 to 40° C. Although not preferable, lower curing temperatures may also be employed, but will result in longer curing times.

It is likewise possible, although not preferable, to cure the composition at higher temperatures, for example 80 to 160° C. or higher.

After the first coating layer has cured, a further coating layer may be applied and likewise cured.

The coating composition of the invention results in coatings having the following features:
an elongation at break of >40% after self-healing for 24 h (i.e. storage at 23° C. and 50% relative humidity), preferably >60%, more preferably >90%,
an elongation at break in the undamaged state (before self-healing test) of >100%, preferably >300%, more preferably >500%, and
a glass transition temperature (determined via maximum tangent delta at 1 Hz) of <23° C., preferably <0° C., more preferably <−10° C.; where a coating has more than one glass transition temperature, at least one of them must meet this condition.
a storage modulus at 23° C. and 1 Hz of >0.7 MPa, preferably >0.8 MPa.

### EXPERIMENTAL

### Methods

Unless indicated otherwise, all percentages are based on weight.

Unless otherwise stated, viscosity was determined at a temperature of 23° C. and a shear rate of 50/s according to DIN 53019.

NCO contents were determined volumetrically in accordance with DIN EN ISO 11909.

Residual diisocyanate and monomer contents were determined in accordance with DIN EN ISO 10283.

Breaking stress and elongation at break were determined in accordance with DIN 53504:2017-03. The test specimens were first stored for 24 h at 23° C. and 50% relative humidity. For the examination of self-healing, the tensile specimens were placed on a flat surface and cut in the middle with a razor blade (Martor, Solingen), transversely to the tensile direction. The cut surfaces were then joined together under slight hand pressure for 3 s. The test specimens were then stored for 24 h at 23° C. and 50% relative humidity and the breaking stress and elongation at break redetermined in accordance with DIN 53504:2017-03.

Dynamic mechanical analysis was carried out on a Mettler DMA SDTA 861 in shear mode. Two cylinders with a diameter of 6 mm were inserted into a double shear test sample holder. The maximum force amplitude was 0.5 N and the maximum elongation was 2 μm. The measurements were carried out in the −100° C. to +150° C. temperature range with a heating rate of 1 K/min and test frequencies of 1, 10, 100, and 500 Hz.

The polyether polyol contents of the monomer-free linear prepolymers 1-10 were calculated according to Flory (P. J. Flory, “Molecular Size Distribution in Linear Condensation Polymers”, JACS 1936, pp. 1877-1885). The polyether polyol contents of undistilled prepolymers (prepolymer 11) were calculated simply via the respective formulation. The polyether polyol contents of the monomer-free branched prepolymers (e.g. Desmodur E30600) were calculated by simulation in accordance with WO 2021/055398 A1.

Gₓ is calculated on the basis of the prepolymer proportions and the polyether polyol contents of the prepolymers determined previously. If the aspartate component A or component C or D contains polyethers, these are also taken into account.

The ability of a coating composition to form close-meshed networks is described by G_{F}.

### Example Calculation for Gₓ Based on Coating Compound 16

As shown in Table 1, coating compound 16 contains 63.42 g of prepolymer 7, 13.02 g of Desmodur N 3600, and 43.55 g of Desmophen NH 1420. The total mass is 119.99 g.

The formulation of prepolymer 7 contains 1680 g of HDI and 1000 g of the polyether Desmophen 1110 BD. The polyether content of the prepolymer prior to distillation is thus 37.3%. According to the Schulz-Flory distribution, 50.8% of the mixture is unreacted monomeric HDI. After distillative removal of the excess monomeric HDI, the polyether content increases to 75.8%. 75.8% of 63.42 g of prepolymer 7 corresponds to 48.07 g of polyether. Since Desmodur N 3600 and Desmophen NH 1420 do not contain polyethers, the percent content of polyethers based on the total mass of components A-D is 100×48.07/119.99=40%. Gₓ is therefore 40%.

### Example Calculation for G_{F} Based on Coating Compound 16

As shown in Table 1, coating compound 16 contains 63.42 g of prepolymer 7, 13.02 g of Desmodur N 3600, and 43.55 g of Desmophen NH 1420. The total mass is 119.99 g.

Prepolymer 7 and Desmophen NH 1420 have a functionality of 2. Desmodur N 3600 has a functionality of >2 and a number-average molecular weight Mn of 710 g/mol. 13.02 g of Desmodur N 3600 therefore corresponds to a molar amount of 0.018 mol in 119.99 g. Based on 1 kg of components A-D, this is 0.15 mol. G_{F} is therefore 0.15 mol/kg.

### Substances and Abbreviations Used

HDJ: Hexamethylene diisocyanate (Desmodur® H, Covestro Deutschland AG)
Poly(tetrahydrofuran): Products having number-average molar masses of 250, 1000, 1400, and 2000 g/mol were purchased from BASF. Poly(tetrahydrofuran) having a number-average molar mass of 650 g/mol was provided by Merck.
Desmodur® N 3600: Product of Covestro Deutschland AG, HDI isocyanurate trimer, functionality >2, NCO content 23%, average molar mass of 710 g/mol (determined by GPC).
Desmodur® E30600: Product of Covestro Deutschland AG, polypropylene glycol-based HDI prepolymer having a functionality of >2, a polyol content of 75.6%, and an average molar mass of 2755 g/mol (determined by GPC).
Desmophen® 1262 BD: Product of Covestro Deutschland AG, difunctional polypropylene glycol having an average molar mass of 431.5 g/mol (OH value 260 mg KOH/g)
Desmophen® 1110 BD: Product of Covestro Deutschland AG, difunctional polypropylene glycol having an average molar mass of 1000 g/mol (OH value 112 mg KOH/g)
Desmophen® 2060 BD: Product of Covestro Deutschland AG, difunctional polypropylene glycol having an average molar mass of 2000 g/mol (OH value 56 mg KOH/g)
Ecoprol® 1000H: Product of SK Chemicals, difunctional poly(propane-1,3-diol) having an average molar mass of 1000 g/mol (OH value 112 mg KOH/g)
Desmophen® NH 1420: Product of Covestro Deutschland AG, difunctional amine having an equivalent weight of 276 g/mol, does not contain polyether groups.

### Prepolymer 1

An initial charge of 1680 g of HDI was heated to 80° C. and 250 g of poly(tetrahydrofuran) having an average molar mass of 250 g/mol (OH value 450 mg KOH/g) was added dropwise over 60 min while stirring. The mixture was stirred at 80° C. for a further 120 min until an NCO content of 38.6% was reached. The excess HDI was removed in a two-stage short-path evaporator (preliminary evaporator 130° C., main evaporator 120° C.) at reduced pressure of 0.08 mbar. A prepolymer that solidified to a white solid on cooling to room temperature was obtained. The following properties were obtained:
NCO content: 13.4%
Residual monomer content: 0.08%
Viscosity at 50° C.: 185 mPas
Polyether polyol content (calculated): 43.9%
Functionality: 2

### Prepolymer 2

An initial charge of 1680 g of HDI was heated to 80° C. and 650 g of poly(tetrahydrofuran) having an average molar mass of 650 g/mol (OH value 173 mg KOH/g) was added dropwise over 60 min while stirring. The mixture was stirred at 80° C. for a further 190 min until an NCO content of 32.2% was reached. The excess HDI was removed in a two-stage short-path evaporator (preliminary evaporator 130° C., main evaporator 120° C.) at reduced pressure of 0.04 mbar. A liquid prepolymer having the following properties was obtained:
NCO content: 7.6%
Residual monomer content: 0.04%
Viscosity: 1610 mPas
Polyether polyol content (calculated): 67.0%
Functionality: 2

### Prepolymer 3

An initial charge of 2520 g of HDI was heated to 80° C. and 1500 g of poly(tetrahydrofuran) having an average molar mass of 1000 g/mol (OH value 112 mg KOH/g) was added dropwise over 60 min while stirring. The mixture was stirred at 80° C. for a further 75 min until an NCO content of 27.9% was reached. The excess HDI was removed in a two-stage short-path evaporator (preliminary evaporator 130° C., main evaporator 120° C.) at reduced pressure of 0.04 mbar. A liquid prepolymer was initially obtained that slowly solidified to a white solid over several days. The following properties were measured:
NCO content: 5.7%
Residual monomer content: 0.04%
Viscosity: 2200 mPas
Polyether polyol content (calculated): 75.8%
Functionality: 2

### Prepolymer 4

An initial charge of 840 g of HDI was heated to 80° C. and 700 g of poly(tetrahydrofuran) having an average molar mass of 1400 g/mol (OH value 80 mg KOH/g) was added dropwise over 60 min while stirring. The mixture was stirred at 80° C. for a further 120 min until an NCO content of 24.3% was reached. The excess HDI was removed in a two-stage short-path evaporator (preliminary evaporator 130° C., main evaporator 120° C.) at reduced pressure of 0.04 mbar. A liquid prepolymer was initially obtained that slowly solidified to a white solid over several days. The following properties were measured:
NCO content: 4.4%
Residual monomer content: 0.03%
Viscosity: 4780 mPas
Polyether polyol content (calculated): 81.4%
Functionality: 2

### Prepolymer 5

An initial charge of 630 g of HDI was heated to 80° C. and 750 g of poly(tetrahydrofuran) having an average molar mass of 2000 g/mol (OH value 56 mg KOH/g) was added dropwise over 105 min while stirring. The mixture was stirred at 80° C. for a further 250 min until an NCO content of 20.5% was reached. The excess HDI was removed in a two-stage short-path evaporator (preliminary evaporator 130° C., main evaporator 120° C.) at reduced pressure of 0.1 mbar. A liquid prepolymer was initially obtained that solidified overnight to a white solid. The following properties were measured:
NCO content: 3.2%
Residual monomer content: 0.02%
Viscosity at 40° C.: 2630 mPas
Polyether polyol content (calculated): 86.2%
Functionality: 2

### Prepolymer 6a

An initial charge of 1680 g of HDI was heated to 80° C. and 431.5 g of Desmophen 1262 BD having an average molar mass of 431.5 g/mol (OH value 260 mg KOH/g) was added dropwise over 60 min while stirring. The mixture was stirred at 80° C. for a further 75 min until an NCO content of 35.7% was reached. The excess HDI was removed in a two-stage short-path evaporator (preliminary evaporator 130° C., main evaporator 120° C.) at reduced pressure of 0.3 mbar. A liquid prepolymer was obtained.
NCO content: 10.3%
Residual monomer content: 0.13%
Viscosity: 1730 mPas
Polyether polyol content (calculated): 57.5%
Functionality: 2

### Prepolymer 6b

An initial charge of 2520 g of HDI was heated to 80° C. and 647.3 g of Desmophen 1262 BD having an average molar mass of 431.5 g/mol (OH value 260 mg KOH/g) was added dropwise over 60 min while stirring. The mixture was stirred at 80° C. for a further 780 min until an NCO content of 35.8% was reached. The excess HDI was removed in a two-stage short-path evaporator (preliminary evaporator 130° C., main evaporator 120° C.) at reduced pressure of 0.4 mbar. A liquid prepolymer was obtained.
NCO content: 10.5%
Residual monomer content: 0.78%
Viscosity: 1610 mPas
Polyether polyol content (calculated): 57.0%
Functionality: 2

### Prepolymer 7

An initial charge of 1680 g of HDI was heated to 80° C. and 1000 g of Desmophen 1110 BD having an average molar mass of 1000 g/mol (OH value 112 mg KOH/g) was added dropwise over 90 min while stirring. The mixture was stirred at 80° C. for a further 260 min until an NCO content of 28.0% was reached. The excess HDJ was removed in a two-stage short-path evaporator (preliminary evaporator 130° C., main evaporator 120° C.) at reduced pressure of 0.08 mbar. A liquid prepolymer was obtained.
NCO content: 5.9%
Residual monomer content: 0.04%
Viscosity: 1500 mPas
Polyether polyol content (calculated): 75.8%
Functionality: 2

### Prepolymer 8

An initial charge of 840 g of HDI was heated to 80° C. and 1000 g of Desmophen 2060 BD having an average molar mass of 2000 g/mol (OH value 56 mg KOH/g) was added dropwise over 90 min while stirring. The mixture was stirred at 80° C. for a further 600 min until an NCO content of 20.5% was reached. The excess HDI was removed in a two-stage short-path evaporator (preliminary evaporator 130° C., main evaporator 120° C.) at reduced pressure of 0.04 mbar. A liquid prepolymer was obtained.
NCO content: 3.3%
Residual monomer content: 0.03%
Viscosity: 1530 mPas
Polyether polyol content (calculated): 86.2%
Functionality: 2

### Prepolymer 9

An initial charge of 1680 g of HDI was heated to 80° C. and 1000 g of Ecoprol H1000 having an average molar mass of 2000 g/mol (OH value 56 mg KOH/g) was added dropwise over 120 min while stirring. The mixture was stirred at 80° C. for a further 150 min until an NCO content of 28.0% was reached. The excess HDI was removed in a two-stage short-path evaporator (preliminary evaporator 130° C., main evaporator 120° C.) at reduced pressure of 0.08 mbar. A liquid prepolymer was obtained.
NCO content: 5.8%
Residual monomer content: 0.07%
Viscosity: 1670 mPas
Polyether polyol content (calculated): 75.8%
Functionality: 2

### Prepolymer 10

An initial charge of 840 g of HDI was heated to 80° C. and 1000 g of Ecoprol H2000 having an average molar mass of 2000 g/mol (OH value 56 mg KOH/g) was added dropwise over 60 min while stirring. The mixture was stirred at 80° C. for a further 284 min until an NCO content of 20.5% was reached. The excess HDI was removed in a two-stage short-path evaporator (preliminary evaporator 130° C., main evaporator 120° C.) at reduced pressure of 0.04 mbar. A liquid prepolymer was obtained.
NCO content: 3.3%
Residual monomer content: 0.07%
Viscosity: 4520 mPas
Polyether polyol content (calculated): 86.2%
Functionality: 2

### Prepolymer 11

Synthesis in accordance with US20040067315 example 3.
NCO content: 1.8%
Viscosity: 13900 mPas
Polyether polyol content (calculated): 90.0%
Concentration of components for which F>2: 0.045 mol/kg

TABLE 1
Production of coating compounds

| | Example | Example | Example | Example | Example | Example | Example |
|---|---|---|---|---|---|---|---|
| | 1 | 2 | 3 | 4 | 5 | 6 | 7 |
| Prepolymer | | | | | | | |
| 1 | 62.68 | 35.90 | | | | | |
| 2 | | 35.90 | 77.37 | | | | |
| 3 | | | | 87.17 | | | 81.85 |
| 4 | | | | | 95.46 | | |
| 5 | | | | | | 98.40 | |
| Desmodur | | | | | | | |
| N 3600 | | | | | | | |
| Desmophen | 55.40 | 49.70 | 38.78 | 32.83 | 27.70 | 20.80 | 32.96 |
| NH 1420 | | | | | | | |
| Total | 118.08 | 121.50 | 116.15 | 120.00 | 123.16 | 119.20 | 114.81 |
| NCO/NH | 1.0 | 1.0 | 1.0 | 1.0 | 1.0 | 1.0 | 0.95 |

| | Example 8 | Example 9 | Example 10 | Example 11 | Example 12 |
|---|---|---|---|---|---|
| Prepolymer | | | | | |
| 3 | 90.50 | 83.26 | | | |
| 6a | | | 73.44 | | |
| 6b | | | | 54.82 | 36.46 |
| 7 | | | | 27.08 | 49.59 |
| Desmophen | 32.96 | 27.70 | 49.86 | 48.09 | 43.96 |
| NH 1420 | | | | | |
| Total | 123.46 | 110.96 | 123.30 | 129.99 | 130.01 |
| NCO/NH | 1.05 | 1.15 | 1.0 | 1.0 | 1.0 |

| | Example 13 | Example 14 | Example 15 | Example 16 |
|---|---|---|---|---|
| Prepolymer | | | | |
| 7 | 88.42 | 79.19 | 79.22 | 63.42 |
| Desmodur | | | 4.38 | 13.02 |
| N 3600 | | | | |
| HDI | | 2.57 | | |
| Desmophen | 33.24 | 38.24 | 36.6 | 43.55 |
| NH 1420 | | | | |
| Total | 121.66 | 120.00 | 120.20 | 119.99 |
| NCO/NH | 1.0 | 1.0 | 1.0 | 1.0 |

| | Example | Example | Example | Example | Example | Example |
|---|---|---|---|---|---|---|
| | 17 | 18 | 19 | 20 | 21 | 22 |
| Prepolymer | | | | | | |
| 8 | 98.82 | 90.50 | 83.57 | 69.70 | 55.86 | 42.03 |
| Desmodur | | 3.66 | 7.04 | 13.79 | 20.53 | 27.27 |
| N 3600 | | | | | | |
| Desmophen | 22.16 | 25.83 | 29.39 | 36.51 | 43.61 | 50.70 |
| NH 1420 | | | | | | |
| Total | 120.98 | 119.99 | 120.00 | 120.00 | 120.00 | 120.00 |
| NCO/NH | 1.0 | 1.0 | 1.0 | 1.0 | 1.0 | 1.0 |

| | Example 23 | Example 24 | Example 25 | Example 26 |
|---|---|---|---|---|
| Prepolymer | | | | |
| 9 | 86.90 | 79.22 | 63.42 | 47.64 |
| Desmodur | | 4.17 | 12.86 | 21.54 |
| N 3600 | | | | |
| Desmophen | 33.24 | 36.61 | 43.72 | 50.82 |
| NH 1420 | | | | |
| Total | 120.14 | 120.00 | 120.00 | 120.00 |
| NCO/NH | 1.0 | 1.0 | 1.0 | 1.0 |

| | Example 27 | Example 28 | Example 29 | Example 30 | Example 31 |
|---|---|---|---|---|---|
| Prepolymer | | | | | |
| 10 | 98.54 | 90.50 | 83.53 | 69.62 | 55.71 |
| Desmodur | | 3.89 | 7.26 | 14.00 | 20.74 |
| N 3600 | | | | | |
| Desmophen | 21.46 | 25.60 | 29.20 | 36.39 | 43.56 |
| NH 1420 | | | | | |
| Total | 120.00 | 119.99 | 119.99 | 120.01 | 120.01 |
| NCO/NH | 1.0 | 1.0 | 1.0 | 1.0 | 1.0 |

| | Example 32 | Example 33 | Example 34 |
|---|---|---|---|
| Prepolymer | | | |
| 11 | 110.25 | 105.00 | |
| Desmodur | | | 86.70 |
| E 30600 | | | |
| Desmophen | 13.85 | 13.85 | 36.00 |
| NH 1420 | | | |
| Total | 124.10 | 118.85 | 122.70 |
| NCO/NH | 1.05 | 1.00 | 1.0 |

In accordance with the formulations in Table 1, the prepolymer was initially charged and Desmophen® NH 1420 added. The mixture was then homogenized for 1 min in the Speedmixer DAC 150 Z.

### Example 35

Coating compound in accordance with WO2020/260578 A1, coating 6.

### Example 36

Pigmented coating compounds were produced in accordance with the formulations in Table 2. This was done by preparing component A in the dissolver (Dispermat, from VMA-Getzmann) and then, after initially charging the Speedmixer (Hausschild DAC 150 FVZ) with the isocyanate prepolymer (component B), mixing for 1 min.

TABLE 2
Production of pigmented coating compounds

| | Example 36 |
|---|---|
| Prepolymer (component B) | |
| 3 | 52.88 |
| Component A | |
| Desmophen NH 1220 | 9.07 |
| Desmophen NH 1420 | 7.66 |
| Disperbyk 110 | 0.66 |
| Pure R 706 titanium dioxide | 24.39 |
| Colour Black FW 200 | 0.07 |
| BYK 327 | 0.27 |
| BYK 331 | 0.14 |
| BYK 1799 | 1.41 |
| Tinuvin 292 | 0.63 |
| 4 A molecular sieve | 2.82 |
| Total | 100 |
| NCO/NH | 1.05 |

### Production of Films

The coating compounds from examples 1-36 were poured into molds. Films were produced that were approx. 5 mm thick for self-healing tests and approx. 3 mm thick for dynamic mechanical analysis. The films were cured at room temperature for at least 14 days.

Table 3 gives an overview of the film properties.

### Rain Erosion Test

45 cm long U-shaped NACA 63-021 test substrates for simulating the wind edge of a wind turbine rotor blade (known as the “leading edge”, as described in Annex A.1, DNGVL-RP-0171) were initially coated with a thin layer of adhesive primer. 400 μm of the example 36 coating compositions (Table 2) was then applied. The coating was cured at room temperature for at least 14 days.

A rain erosion test was carried out in accordance with DNVGL-RP 0171 with a rotor speed of 1000 rpm, water volume flow of 65 L/h, rain intensity of 31.34 mm/h, an average drop size of 2.511 mm, and a test room temperature of between 14 and 23° C. The inspection interval was 15 min. The coating showed no erosion damage even after a test period of 20 h.

TABLE 3
Film properties of the films produced from coating compounds 1-35

| | | | | | | | Storage | | | | |
|---|---|---|---|---|---|---|---|---|---|---|---|
| | | | | | | | modulus | | | Breaking | Elongation |
| | | Poly- | Molar | | | Tg | G′ | | | stress | at break |
| | Diiso- | ether | mass of | | | (max. tangent | (23° C., | Breaking | Elongation | after | after |
| | cyanate | polyol | polyol | G_{F} | G_{X} | delta, 1 Hz) | 1 Hz) | stress | at break | healing | healing |
| Example | B1 | B2 | [g/mol] | [mol/kg] | [% by wt.] | [° C.] | [MPa] | [MPa] | [%] | [MPa] | [%] |
| 1 (C) | HDI | PTHF | 250 | 0 | 23 | 43 | 345 | 19.2 | 245 | 0* | 0* |
| 2 (I) | HDI | PTHF | mixture | 0 | 36 | 20 | 4.3 | 2.4 | 438 | 1.1 | 132 |
| | | | of 250 | | | | | | | | |
| | | | and 650 | | | | | | | | |
| 3 (I) | HDI | PTHF | 650 | 0 | 45 | −4 | 1.4 | 1.9 | 759 | 0.7 | 97 |
| 4 (I) | HDI | PTHF | 1000 | 0 | 55 | −17 | 1.3 | 3.4 | 972 | 1.0 | 112 |
| 5 (I) | HDI | PTHF | 1400 | 0 | 63 | −39 | 0.9 | 1.4 | 835 | 0.7 | 188 |
| 6 (C) | HDI | PTHF | 2000 | 0 | 73 | −19** | 26.5 | 3.8 | 462 | 0* | 0* |
| 7 (I) | HDI | PTHF | 1000 | 0 | 54 | −23 | 1.3 | 2.7 | 1011 | 0.7 | 125 |
| 8 (I) | HDI | PTHF | 1000 | 0 | 56 | −23 | 1.3 | 1.4 | 705 | 0.6 | 97 |
| 9 (I) | HDI | PTHF | 1000 | 0 | 57 | −26 | 1.6 | 1.2 | 654 | 0.5 | 171 |
| 10 (C) | HDI | PPG | 431.5 | 0 | 34 | 27 | 21 | 18 | 362 | 0* | 0* |
| 11 (I) | HDI | PPG | mixture | 0 | 40 | 14 | 2.0 | 2.9 | 635 | 0.9 | 273 |
| | | | of 431.5 | | | | | | | | |
| | | | and 1000 | | | | | | | | |
| 12 (I) | HDI | PPG | mixture | 0 | 45 | 7 | 1.4 | 2.1 | 769 | 0.6 | 228 |
| | | | of 431.5 | | | | | | | | |
| | | | and 1000 | | | | | | | | |
| 13 (C) | HDI | PPG | 1000 | 0 | 55 | −16 | 0.6 | >0.17 | >1549 | 0.2 | 886 |
| 14 (C) | HDI | PPG | 1000 | 0 | 50 | −6 | 0.7 | 0.7 | 957 | 0.2 | 449 |
| 15 (I) | HDI | PPG | 1000 | 0.05 | 50 | −5 | 0.8 | 4.8 | 523 | 0.4 | 45 |
| 16 (C) | HDI | PPG | 1000 | 0.15 | 40 | 23 | 7.0 | 12.4 | 269 | 0* | 0* |
| 17 (C) | HDI | PPG | 2000 | 0 | 70 | −40 | 0.4 | 0.08 | 1578 | 0.04 | 1120 |
| 18 (C) | HDI | PPG | 2000 | 0.04 | 65 | −38 | 0.7 | 3.5 | 629 | 0.4 | 125 |
| 19 (I) | HDI | PPG | 2000 | 0.08 | 60 | −39/−4*** | 1.1 | 4.1 | 378 | 0.7 | 83 |
| 20 (C) | HDI | PPG | 2000 | 0.16 | 50 | −43/32*** | 11 | 6.7 | 202 | 1.5 | 24 |
| 21 (C) | HDI | PPG | 2000 | 0.24 | 40 | −40/62*** | 68 | 12.1 | 161 | 0* | 0* |
| 22 (C) | HDI | PPG | 2000 | 0.32 | 30 | −39/72*** | 94 | 15.1 | 104 | 0* | 0* |
| 23 (I) | HDI | PO3G | 1000 | 0 | 55 | −17 | 1.3 | >4.5 | >1144 | 0.6 | 112 |
| 24 (I) | HDI | PO3G | 1000 | 0.05 | 50 | −7 | 2.3 | 6.0 | 441 | 0.7 | 46 |
| 25 (C) | HDI | PO3G | 1000 | 0.15 | 40 | 23 | 9.4 | 10.1 | 239 | 1.4 | 40 |
| 26 (C) | HDI | PO3G | 1000 | 0.25 | 30 | 49 | 140 | 16.7 | 141 | 0* | 0* |
| 27 (I) | HDI | PO3G | 2000 | 0 | 71 | −44 | 1.2 | >1.4 | >1584 | 0.5 | 154 |
| 28 (I) | HDI | PO3G | 2000 | 0.05 | 65 | −52/−15*** | 1.4 | 1.9 | 328 | 0.7 | 56 |
| 29 (C) | HDI | PO3G | 2000 | 0.09 | 60 | −56/8*** | 3.3 | 2.9 | 222 | 0.8 | 32 |
| 30 (C) | HDI | PO3G | 2000 | 0.16 | 50 | −59/50*** | 24 | 7.2 | 191 | 2.1 | 20 |
| 31 (C) | HDI | PO3G | 2000 | 0.24 | 40 | −60/70*** | 61 | 13.2 | 179 | 0.7 | 1 |
| 32 (C) | IPDI | PPG | mixture | 0.04 | 81 | −49 | 0.3 | 1.4 | 781 | 0.3 | 128 |
| | | | of 4000 | | | | | | | | |
| | | | and 6000 | | | | | | | | |
| 33 (C) | IPDI | PPG | mixture | 0.04 | 80 | −49 | 0.3 | 2.6 | 1144 | 0.3 | 133 |
| | | | of 4000 | | | | | | | | |
| | | | and 6000 | | | | | | | | |
| 34 (C) | HDI | PPG | 2000 | 0.26 | 53 | −32/7 | 1.9 | 1.9 | 73 | 0* | 0* |
| 35 (C) | HDI | PPG | 2000 | 0.26 | 67**** | −25 | 0.9 | 2.2 | 88 | 0* | 0* |
| 36 (I) | HDI | PTHF | 1000 | 0 | 55 | −25 | 1.8 | 4.3 | 627 | 0.9 | 80 |

*Tensile test not possible, as the material does not show self-healing.
**In addition to a broad glass transition at −19.2° C., this coating shows a melting point with onset of melting at approx. 30° C..
***Coating shows two glass transition temperatures.
****Example 35 corresponds to coating 6 of WO2020/260578 A1 and is based on a polyether allophanate prepolymer and a polyether aspartate.
The calculation of Gx took appropriate account of the polyether polyamine content of the aspartate.

Table 3 shows the film properties of the films produced from coating compounds 1-35. Examples 1-9 and 36 show coatings comprising poly(tetrahydrofuran). Adequate self-healing properties are observed only at poly(tetrahydrofuran) contents of between 35 and 72%. Example 36 additionally shows a rain erosion resistance of at least 20 h. Examples 7 to 9 were produced at varying NCO:NH ratios of 0.95, 1.05, and 1.15 and demonstrate that the task can be accomplished with varying NCO:NH ratios. Examples 10-22 and 32-35 show coatings comprising poly(propylene glycol). Similarly to poly(tetrahydrofuran), coatings having poly(propylene glycol) contents below 35% do not show self-healing (see examples 10 and 22). In contrast to poly(tetrahydrofuran), coatings comprising poly(propylene glycol) can show self-healing properties even at very high poly(propylene glycol) content (see examples 17, 32, 33), but these then exhibit high tack. Example 32 was carried out in accordance with US20040067315, Table 1, entry 9. The increased tack is confirmed by the very low storage modulus. Weakly crosslinked coatings (G_{F}=0 to <0.05 mol/kg) become too tacky at poly(propylene glycol) contents of 50% and upward, i.e. a storage modulus of 0.7 or less. This can be partially compensated by crosslinking (see examples 15 and 19 where G_{F} is ≥0.05). However, if there is too much crosslinking, the self-healing properties are again lost (see examples 16, 20, 21, 34, 35). Example 35 was carried out in accordance with WO20260578, coating 6. Examples 23 to 31 show coatings comprising poly(propane-1,3-diol). Similarly to the coating compounds comprising poly(tetrahydrofuran), coating compounds comprising poly(propane-1,3-diol) show self-healing properties in the range Gₓ≤35% to ≤72% and G_{F}<0.09 mol/kg.

1. A two-component coating composition comprising
A) at least one polyaspartic-ester-containing component that comprises
one or more polyaspartic esters of the general formula (I) 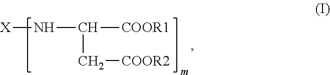
in which
m is an integer >1,
X is an m-valent organic radical, and is in the 60 to 6000 g/mol molecular weight range, and
the radicals R1 and R2 are identical or different organic radicals each having 1 to 18 carbon atoms,
and optionally one or more polyaspartic esters of the general formula (II) 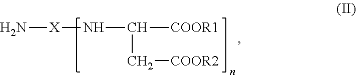
in which n is m-1, and X and the radicals R1 and R2 are as defined above,
and is a reaction product comprising:
A1) at least one polyamine or polyether polyamine of the general formula (III), 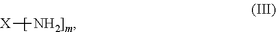
in which m and X are as defined above, with
A2) at least one compound of the general formula (IV)
R1OOCH═CH—COOR² (IV),
in which R1 and R2 are as defined above,
B) at least one NCO-functional polyurethane prepolymer reaction product comprising,
B1) at least one polyisocyanate with
B2) at least one polyether polyol having linear ether groups or branched ether groups of the following general formulas (V) to (VII):
—O—(CH₂)ₓ— (V), where x=2 to 10,
—O—CR³R⁴—CH₂— (VI), where R³ and R⁴ are independent of one another and are hydrogen or an aliphatic linear or branched, saturated or unsaturated radical having up to 10 carbon atoms, which may also include oxygen atoms, or an aromatic radical having up to 10 carbon atoms, but where at least one of the radicals R³ or R⁴ is not hydrogen, and
—O—CR⁵R⁶—CR⁷R⁸— (VII), where R⁵ to R⁸ are independent of one another and where R⁵ and R⁷ are hydrogen or an aliphatic linear or branched, saturated or unsaturated radical having up to 10 carbon atoms, which may also include oxygen atoms, and R⁶ and R⁸ are an aliphatic linear or branched, saturated or unsaturated radical having up to 10 carbon atoms, which may also include oxygen atoms, or R⁶ and R⁸ are joined to one another so as to form a saturated or unsaturated ring having up to 8 carbon atoms that may be substituted with organic radicals,
B3) optionally at least one polyol different from B2,
C) optionally one or more isocyanate-reactive components that are different from A,
D) optionally one or more isocyanate components D different from B, selected from the group comprising D1) modified polyisocyanates obtainable from the reaction of monomeric polyisocyanates with polyols and D2) further isocyanate components different from D1,
E) -E1) optionally auxiliaries and/or additives, excluding those of components E2 and E3,
E2) optionally inorganic fillers and/or inorganic pigments,
and/or
E3 optionally solvents,
where Gₓ is defined as the total amount of
polyether polyamines of the formula III incorporated into the polyaspartic esters of the polyaspartic-ester-containing component A,
polyether polyols B2 and polyols B3 incorporated into the polyurethane prepolymers B,
polyols and polyether polyamines coming under component C, and
polyols incorporated into the modified polyisocyanates D1,
based on the total weight of the components A to E1,
and G_{F} is defined as
the total amount of components A to D having a functionality of >2 based on 1 kg of components A to E1,
where the functionality comprises the isocyanate groups and isocyanate-reactive groups,
and where:
i) when component B2 comprises ≤100 to ≥70 percent by weight of linear ether groups and ≥0 to ≤30 percent by weight of branched ether groups, in each case based on the total amount of linear and branched ether groups in component B2, then Gₓ is ≥35 to ≤72 percent by weight and G_{F} is ≥0 to <0.09 mol/kg, and
ii) when component B2 comprises ≥0 to <70 percent by weight of linear ether groups and ≤100 to >30 percent by weight of branched ether groups, in each case based on the total amount of linear and branched ether groups in component B2, then
ii₁) if G_{F} is ≥0 to <0.05 mol/kg, then Gₓ is ≥35 to <50 percent by weight, or
ii₂) if G_{F} is ≥0.05 to <0.09 mol/kg, then Gₓ is ≥35 to ≤65 percent by weight.

2. The two-component coating composition of claim 1, wherein:
component B2 comprises ≤100 to ≥70 percent by weight of linear ether groups and ≥0 to ≤30 percent by weight of branched ether groups, in each case based on the total amount of linear and branched ether groups in component B2, and Gₓ is ≥35 to ≤72 percent by weight and G_{F} is ≥0 to <0.09 mol/kg.

3. The two-component coating composition of claim 1, wherein:
i) when component B2 comprises ≤100 to ≥70 percent by weight of linear ether groups and ≥0 to ≤30 percent by weight of branched ether groups, in each case based on the total amount of linear and branched ether groups in component B2, then Gx is ≥35 to ≤72 percent by weight and G_{F} is ≥0 to ≤0.05 mol/kg.

4. The two-component coating composition of claim 1, wherein:
i) when component B2 comprises ≤100 to ≥70 percent by weight of linear ether groups and ≥0 to ≤30 percent by weight of branched ether groups, in each case based on the total amount of linear and branched ether groups in component B2, then Gx is ≥40 to ≤68 percent by weight and G_{F} is ≥0 to ≤0.05 mol/kg.

5. The two-component coating composition of claim 1, wherein:
ii) when component B2 comprises ≥0 to <70 percent by weight of linear ether groups and ≤100 to >30 percent by weight of branched ether groups, in each case based on the total amount of linear and branched ether groups in components B2, then
ii₁) if G_{F} is ≥0 to >0.05 mol/kg, then Gₓ is ≥35 to >50 percent by weight, or
ii₂) if G_{F} is ≥0.05 to <0.08 mol/kg, then Gₓ is ≥35 to ≤65 percent by weight.

6. The two-component coating composition of claim 1, wherein the at least one polyisocyanate B1 comprises: monomeric diisocyanates in the 140 to 400 g/mol molecular weight range having linear-aliphatically, cycloaliphatically, araliphatically or aromatically attached isocyanate groups and polyisocyanates with an NCO functionality of ≥2 and having uretdione, isocyanurate, allophanate, urea, biuret, iminooxadiazinedione or oxadiazinetrione structures with linear-aliphatically, cycloaliphatically, araliphatically or aromatically attached isocyanate groups.

7. The two-component coating composition of claim 1, wherein the at least one polyisocyanate B1 is a monomeric diisocyanate in the 140 to 400 g/mol molecular weight range having exclusively linear-aliphatically or cycloaliphatically attached isocyanate groups.

8. The two-component coating composition of claim 1, wherein x in formula (V) is 2 to 6.

9. The two-component coating composition of claim 1, wherein for formula (VI) the following applies: R³ is hydrogen and R⁴ is an aliphatic linear or branched, saturated or unsaturated radical having up to 10 carbon atoms.

10. The two-component coating composition of claim 1, wherein for formula (VI): R³ is hydrogen and R⁴ is an aliphatic linear or branched, saturated radical having up to 6 carbon atoms.

11. A process for producing a coating on a substrate comprising at least the following steps:
i) applying a two-component coating composition as claimed in claim 1 to at least part of a substrate to be coated and
ii) curing the coating composition from step i).

12. A substrate coated with the two-component coating of claim 1.

13. (canceled)

14. The substrate of claim 12, wherein the substrate is a rotor blade of wind turbines or helicopters.

15. (canceled)

16. The two-component coating composition of claim 1, wherein, in general formula (I) of component A), m is 2.

17. The two-component coating composition of claim 1, wherein, in general formula (I) of component A), X is an m-valent organic radical, containing one or more heteroatoms, with its primary amino groups removed from a polyamine or polyetheramine that has cycloaliphatically, linear-aliphatically or araliphatically attached primary amino groups.

18. The two-component coating composition of claim 1, wherein, in general formula (I) of component A), X is an m-valent organic radical, and comprises functional groups reactive toward isocyanate groups or functional groups inert at temperatures of up to 100° C.

19. The two-component coating composition of claim 1, wherein x in formula (V) is 2 to 4.

20. The two-component coating composition of claim 1, wherein for formula (VI): R3 is hydrogen and R4 is a methyl radical.
